(19) United States
(12) Patent Application Publication
(10) Pub. No.: US 2014/0067268 A1
(43) Pub. Date: Mar. 6, 2014

(54) Systems and Methods for Monitoring a Subsea Environment

(71) Applicants: Ola Tunheim, Bryne (NO); Robert P. Freese, Pittsboro, NC (US); Laurence J. Abney, Sandnes (NO); James R. MacLennan, Aberdeen (GB)

(72) Inventors: Ola Tunheim, Bryne (NO); Robert P. Freese, Pittsboro, NC (US); Laurence J. Abney, Sandnes (NO); James R. MacLennan, Aberdeen (GB)

(73) Assignee: Halliburton Energy Services, Inc., Houston, TX (US)

(21) Appl. No.: 13/598,693

(22) Filed: Aug. 30, 2012

(51) Int. Cl. G06F 19/00

(52) U.S. Cl. 702/2

(57) ABSTRACT

Disclosed are systems and methods for monitoring an oceanic environment for hazardous substances. One system includes one or more subsea equipment arranged in an oceanic environment, and at least one optical computing device arranged on or near the one or more subsea equipment for monitoring the oceanic environment. The at least one optical computing device may have at least one integrated computational element configured to optically interact with the oceanic environment and thereby generate optically interacted light. At least one detector may be arranged to receive the optically interacted light and generate an output signal corresponding to a characteristic of the oceanic environment.

### BACKGROUND

The present invention relates to optical analysis systems and, in particular, systems and methods for monitoring an oceanic environment for hazardous substances.

As the oil and gas industry moves into deeper waters across the globe, the capabilities of subsea wellbore equipment and control systems are severely tested. In spite of significant advances in engineering, the complexity of the systems and the number of individual components in deepwater systems create numerous potential leak sites. Over the life of a subsea system, it is possible for a leak to occur in most of the components of a subsea well system. For example, connection leaks are often found in umbilical lines, hydraulic lines, control systems, flow hubs, casing, and similar components. Dynamic seal leaks are often experienced in surface-controlled subsurface safety valves (SCSSV), actuators, valves control systems and similar components. Static seal leaks are often seen in wellheads, packers, hangers, subsea separation and compression systems, and similar components.

Leaks can result in abnormal pressures in the wellbore equipment or releases of control fluids, oil, gas, or other potentially hazardous substances into the surrounding environment. Today, both subsea operators and authority awareness towards the environmental impact of subsea leakage is constantly increasing and, as a result, operators are facing tighter environmental regulations. In addition to the adverse affects suffered by the environment and the attendant safety concerns, subsea leaks can also result in fines, extra costs related to the substance removal, and bad publicity.

Monitoring subsea systems for hazardous substances is complicated by the remoteness of the equipment and the uniqueness of many of the subsea installations. Essentially, the only means of analyzing subsea well leaks is through remote diagnostics, which are often limited to using dyes, visual sightings of gas bubbles, or simply taking pressure readings. Such methods are sometimes inaccurate and usually difficult to conduct. As a result, many leaks go undetected by conventional detection means. For operations in areas of environmental sensitivity, extra attention is needed to mitigate negative environmental side effects.

### SUMMARY OF THE INVENTION

The present invention relates to optical analysis systems and, in particular, systems and methods for monitoring an oceanic environment for hazardous substances.

In some aspects of the disclosure, a system is disclosed that includes one or more subsea equipment arranged in an oceanic environment, and at least one optical computing device arranged on or in proximity to the one or more subsea equipment for monitoring the oceanic environment, the at least one optical computing device having at least one integrated computational element configured to optically interact with the oceanic environment and thereby generate optically interacted light, and at least one detector arranged to receive the optically interacted light and generate an output signal corresponding to a characteristic of the oceanic environment.

In other aspects of the disclosure, a method of monitoring a fluid disclosed. The method may include arranging at least one optical computing device within an oceanic environment that includes one or more subsea equipment, the at least one optical computing device having at least one integrated computational element and at least one detector arranged therein, disposing the at least one optical computing device on or in proximity to the one or more subsea equipment, and generating with the at least one detector an output signal corresponding to a characteristic of the oceanic environment.

In yet other aspects of the disclosure, a method of monitoring a quality of a fluid is disclosed. The method may include optically interacting electromagnetic radiation from an oceanic environment with at least one integrated computational element, thereby generating optically interacted light, wherein the oceanic environment has one or more subsea equipment arranged therein, receiving with at least one detector the optically interacted light, measuring a characteristic of at least one hazardous substance present in the oceanic environment with the at least one detector, generating an output signal corresponding to the characteristic of the at least one hazardous substance in the oceanic environment, and undertaking at least one corrective step when the characteristic of the at least one hazardous substance in the oceanic environment surpasses a predetermined range of suitable operation.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates an exemplary integrated computation element, according to one or more embodiments.

FIG. 2 illustrates a block diagram non-mechanistically illustrating how an optical computing device distinguishes electromagnetic radiation related to a characteristic of interest from other electromagnetic radiation, according to one or more embodiments.

FIG. 3 illustrates an exemplary oceanic environment being monitored for hazardous substances by one or more optical computing devices.

FIG. 4 illustrates an exemplary optical computing device for monitoring a fluid present in a flow path, according to one or more embodiments.

### DETAILED DESCRIPTION

The present invention relates to optical analysis systems and, in particular, systems and methods for monitoring an oceanic environment for hazardous substances.

The exemplary systems and methods described herein employ various configurations of optical computing devices, also commonly referred to as “opticoanalytical devices,” for the real-time or near real-time monitoring of bodies of water, such as oceanic environments. In operation, the exemplary systems and methods may be useful and otherwise advantageous in determining the presence and/or concentration of hazardous substances that may exist around subsea oil and gas equipment. For example, the optical computing devices, which are described in more detail below, can advantageously provide real-time or near real-time monitoring of the water surrounding subsea equipment that cannot presently be achieved with either onsite analyses at a job site or via more detailed analyses that take place in a laboratory. A significant and distinct advantage of these devices is that they can be configured to specifically detect and/or measure a particular component or characteristic of interest of a fluid, such as a hazardous substance present in seawater, thereby allowing qualitative and/or quantitative analyses of the fluid to occur without having to extract a sample and undertake time-consuming analyses of the sample at an off-site laboratory. In some cases, the devices can monitor how the presence of a hazardous substance in an oceanic environment changes based on activity undertaken in the vicinity, such as increases in the hazardous substance or remedial efforts focused on removing the hazardous substance.

With the ability to undertake real-time or near real-time analyses, the exemplary systems and methods described herein may be able to provide a timely indication of either healthy or unhealthy oceanic environments surrounding various subsea equipment. For example, in some cases, the systems and methods may be useful in monitoring healthy oceanic environment indicators, such as dissolved oxygen content, planctonics, etc. In other cases, the systems and methods may be useful in the early detection of hydrocarbon leaks or the leakage of other environmentally hazardous substances or materials from subsea equipment. Once a hazardous substance is detected in the surrounding water, an alert of the measured condition may be transmitted to the surface, for example, such that remedial efforts may be undertaken before oceanic toxicity levels surpass a predetermined “healthy” limit, and thereby expose a subsea operator to environmental and safety concerns, fines, unnecessary removal/remedial costs, and negative publicity. However, in cases where the oceanic environment is being monitored for healthy environment indicators, an alert may be periodically transmitted to the surface indicating that the predetermined healthy limit has not been surpassed or otherwise breached.

Those skilled in the art will readily appreciate that the disclosed systems and methods may be suitable for use in the oil and gas industry since the described optical computing devices provide a cost-effective, rugged, and accurate means for monitoring subsea equipment in order to facilitate the efficient management of oil/gas production. It will be appreciated, however, that the various disclosed systems and methods are equally applicable to other technology fields including, but not limited to, the food industry, industrial applications, mining industries, military fields, emergency response, spill cleaning technology, harbor monitoring initiatives, or any field where it may be advantageous to determine in real-time or near real-time the concentration or a characteristic of a hazardous substance present in a fluid.

As used herein, the term “fluid” refers to any substance that is capable of flowing, including particulate solids, liquids, gases, slurries, emulsions, powders, muds, glasses, combinations thereof, and the like. In some embodiments, the fluid can be an aqueous fluid, including water, such as seawater, or the like. In some embodiments, the fluid can be a non-aqueous fluid, including organic compounds, more specifically, hydrocarbons, oil, a refined component of oil, petrochemical products, and the like. In some embodiments, the fluid can be a treatment fluid or a formation fluid. Fluids can include various flowable mixtures of solids, liquids and/or gases. Illustrative gases that can be considered fluids according to the present embodiments include, for example, air, nitrogen, carbon dioxide, argon, helium, methane, ethane, butane, and other hydrocarbon gases, combinations thereof and/or the like.

As used herein, the term “characteristic” refers to a chemical, mechanical, or physical property of a substance or material. A characteristic of a substance may include a quantitative value or a concentration of one or more chemical components therein. Such chemical components may be referred to herein as “analytes.” Illustrative characteristics of a substance that can be monitored with the optical computing devices disclosed herein can include, for example, chemical composition (e.g., identity and concentration in total or of individual components), impurity content, pH, viscosity, density, ionic strength, total dissolved solids, salt content, porosity, opacity, bacteria content, combinations thereof, and the like.

As used herein, the term “hazardous substance,” or variations thereof, refers to a matter or material of interest to be evaluated using the optical computing devices described herein. In some embodiments, the hazardous substance is the characteristic of interest, as defined above, and may include any fluid emission from various subsea equipment. The hazardous substance may be a substance that damages or otherwise degrades the overall health of an oceanic environment. In other embodiments, the hazardous substance may simply be an undesirable substance found in the oceanic environment or in any other fluid or substance, but not necessarily a substance that would be considered “hazardous,” per se. For example, the hazardous substance may include a salt residing in fresh water, or fresh water when salt water is expected. In yet other embodiments, the hazardous substance may include one or more tags or dyes used in subsea testing operations, which also may not necessarily be considered “hazardous” in the general sense of the term.

In one or more embodiments, the hazardous substance may include chemicals such as BTEX compounds (i.e., benzene, toluene, ethylbenzene, and xylenes), volatile organic compounds (VOCs), naphthalene, styrene, sulfur compounds, hexane, hydrocarbons, liquefiable hydrocarbons, barium, calcium, manganese, combinations thereof, and any combination thereof. In other embodiments, the hazardous substance may include or otherwise refer to paraffins, waxes, asphaltenes, aromatics, saturates, foams, salts, bacteria, ballast water from foreign waters (including planctonics, algae, fungi, etc.), combinations thereof, and the like. In yet other embodiments, the hazardous substance may include compounds containing elements such as barium, calcium, manganese, sulfur, iron, strontium, chlorine.

In other aspects, the hazardous substance may include any substance used in wellbore operations such as, but not limited to, acids, acid-generating compounds, bases, base-generating compounds, biocides, surfactants, scale inhibitors, corrosion inhibitors, gelling agents, crosslinking agents, anti-sludging agents, foaming agents, defoaming agents, antifoam agents, emulsifying agents, de-emulsifying agents, iron control agents, proppants or other particulates, gravel, particulate diverters, salts, fresh water, fluid loss control additives, gases, catalysts, clay control agents, chelating agents, corrosion inhibitors, dispersants, flocculants, scavengers (e.g., H₂S scavengers, CO₂ scavengers or O₂ scavengers), lubricants, breakers, delayed release breakers, friction reducers, bridging agents, viscosifiers, weighting agents, solubilizers, rheology control agents, viscosity modifiers, pH control agents (e.g., buffers), hydrate inhibitors, relative permeability modifiers, diverting agents, consolidating agents, fibrous materials, bactericides, tracers, probes, nanoparticles, dyes, N₂, CO₂, and the like. Combinations of these substances can be present as well.

As used herein, the term “subsea equipment” refers to any device, manufacture, component, and/or accessory used in the extraction, production, preparation, delivery, or maintenance of hydrocarbons from a subterranean formation. In some embodiments, subsea equipment may refer to such subsea devices as wellheads, blow out preventers, packers, hangers, separation systems, gas compression systems, process facilities, any subsea installation known in the art, combinations thereof, and the like. In other embodiments, subsea equipment may refer to any subsea transport or containment vessel such as flowlines, flowline connection points, pipelines, pipeline end manifolds, PIG launchers, PIG receivers, hot stabs, pipeline end templates, initiation heads, laydown heads, pipeline terminations, hoses, umbilical lines, hydraulic lines, control systems, flow hubs, casing, production tubulars, storage vessels, transport vessels, subterranean formations, combinations thereof, and the like. In yet other embodiments, subsea equipment may refer to surface-controlled subsurface safety valves (SCSSV), actuators, valves control systems and similar components. In yet further embodiments, subsea equipment may refer to equipment that is arranged at the surface and not totally submerged, such a buoys, the hull of a ship, or the like.

As used herein, the term “electromagnetic radiation” refers to radio waves, microwave radiation, infrared and near-infrared radiation, visible light, ultraviolet light, X-ray radiation and gamma ray radiation.

As used herein, the term “optical computing device” refers to an optical device that is configured to receive an input of electromagnetic radiation from a substance or sample of the substance, and produce an output of electromagnetic radiation from a processing element arranged within the optical computing device. The processing element may be, for example, an integrated computational element (ICE) used in the optical computing device. As discussed in greater detail below, the electromagnetic radiation that optically interacts with the processing element is changed so as to be readable by a detector, such that an output of the detector can be correlated to at least one characteristic of the substance being measured or monitored. The output of electromagnetic radiation from the processing element can be reflected electromagnetic radiation, transmitted electromagnetic radiation, and/or dispersed electromagnetic radiation. Whether reflected or transmitted electromagnetic radiation is analyzed by the detector may be dictated by the structural parameters of the optical computing device as well as other considerations known to those skilled in the art. In addition, emission and/or scattering of the substance, for example via fluorescence, luminescence, Raman scattering, and/or Raleigh scattering, can also be monitored by the optical computing devices.

As used herein, the term “optically interact” or variations thereof refers to the reflection, transmission, scattering, diffraction, or absorption of electromagnetic radiation either on, through, or from one or more processing elements (i.e., integrated computational elements). Accordingly, optically interacted light refers to light that has been reflected, transmitted, scattered, diffracted, or absorbed by, emitted, or re-radiated, for example, using the integrated computational elements, but may also apply to interaction with a fluid or a substance in the fluid.

The exemplary systems and methods described herein will include at least one optical computing device arranged or otherwise in proximity to various subsea equipment in order to monitor the oceanic environment for hazardous substances. The optical computing device may include an electromagnetic radiation source, at least one processing element (e.g., integrated computational elements), and at least one detector arranged to receive optically interacted light from the at least one processing element. As disclosed below, however, in at least one embodiment, the electromagnetic radiation source may be omitted and instead the electromagnetic radiation may be derived from the oceanic environment or the hazardous substance(s) itself. In some embodiments, the exemplary optical computing devices may be specifically configured for detecting, analyzing, and quantitatively measuring a particular characteristic or analyte of interest of the fluid in the flow path. In other embodiments, the optical computing devices may be general purpose optical devices, with post-acquisition processing (e.g., through computer means) being used to specifically detect the characteristic of the oceanic environment or the hazardous substance(s).

In some embodiments, suitable structural components for the exemplary optical computing devices are described in commonly owned U.S. Pat. Nos. 6,198,531; 6,529,276; 7,123,844; 7,834,999; 7,911,605; 7,920,258; and 8,049,881, each of which is incorporated herein by reference in its entirety, and U.S. patent application Ser. Nos. 12/094,460; 12/094,465; and 13/456,467, each of which is also incorporated herein by reference in its entirety. As will be appreciated, variations of the structural components of the optical computing devices described in the above-referenced patents and patent applications may be suitable, without departing from the scope of the disclosure, and therefore, should not be considered limiting to the various embodiments disclosed herein.

The optical computing devices described in the foregoing patents and patent applications combine the advantage of the power, precision and accuracy associated with laboratory spectrometers, while being extremely rugged and suitable for field use. Furthermore, the optical computing devices can perform calculations (analyses) in real-time or near real-time without the need for time-consuming sample processing. In this regard, the optical computing devices can be specifically configured to detect and analyze particular characteristics and/or analytes of interest of a fluid or a substance in the fluid, such as a hazardous substance present in an oceanic environment. As a result, interfering signals are discriminated from those of interest in the substance by appropriate configuration of the optical computing devices, such that the optical computing devices provide a rapid response regarding the characteristics of the fluid or substance as based on the detected output. In some embodiments, the detected output can be converted into a voltage that is distinctive of the magnitude of the characteristic being monitored in the fluid. The foregoing advantages and others make the optical computing devices particularly well suited for field, subsea, and downhole use.

The optical computing devices can be configured to detect not only the composition and concentrations of a hazardous substance in a fluid, but they also can be configured to determine physical properties and other characteristics of the hazardous substance as well, based on an analysis of the electromagnetic radiation received from the particular hazardous substance. For example, the optical computing devices can be configured to determine the concentration of an analyte and correlate the determined concentration to a characteristic of a hazardous substance by using suitable processing means. As will be appreciated, the optical computing devices may be configured to detect as many hazardous substances or as many characteristics or analytes of the hazardous substance as desired in the fluid (e.g., seawater). All that is required to accomplish the monitoring of multiple characteristics and/or hazardous substances is the incorporation of suitable processing and detection means within the optical computing device for each hazardous substance and/or characteristic. In some embodiments, the properties of the hazardous substance can be a combination of the properties of the analytes therein (e.g., a linear, non-linear, logarithmic, and/or exponential combination). Accordingly, the more characteristics and analytes that are detected and analyzed using the optical computing devices, the more accurately the properties of the given hazardous substance will be determined.

The optical computing devices described herein utilize electromagnetic radiation to perform calculations, as opposed to the hardwired circuits of conventional electronic processors. When electromagnetic radiation interacts with a hazardous substance in a fluid, unique physical and chemical information about the hazardous substance may be encoded in the electromagnetic radiation that is reflected from, transmitted through, or radiated from the hazardous substance. This information is often referred to as the spectral “fingerprint” of the hazardous substance. The optical computing devices described herein are capable of extracting the information of the spectral fingerprint of multiple characteristics or analytes within a hazardous substance, and converting that information into a detectable output regarding the overall properties of the hazardous substance. That is, through suitable configurations of the optical computing devices, electromagnetic radiation associated with a characteristic or analyte of interest of a hazardous substance can be separated from electromagnetic radiation associated with all other components of the fluid in order to estimate the properties of the hazardous substance in real-time or near real-time.

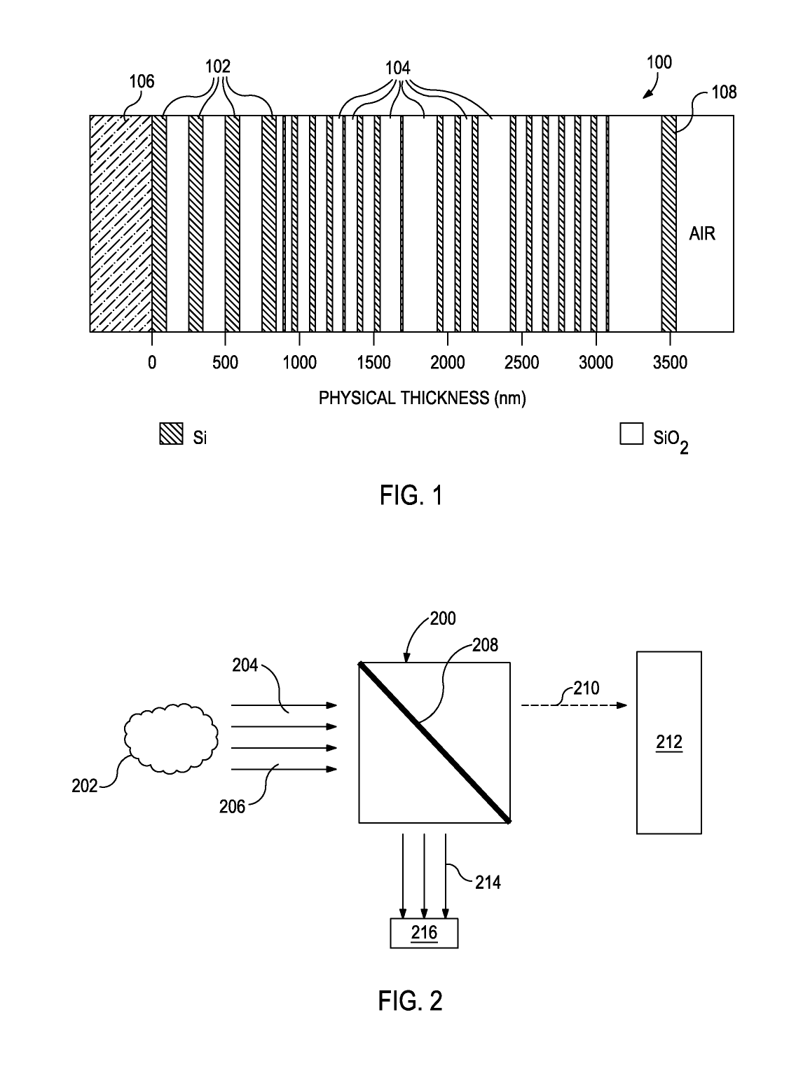

The processing elements used in the exemplary optical computing devices described herein may be characterized as integrated computational elements (ICE). Each ICE is capable of distinguishing electromagnetic radiation related to the characteristic or hazardous substance of interest from electromagnetic radiation related to other components of a fluid. Referring to FIG. 1, illustrated is an exemplary ICE 100 suitable for use in the optical computing devices used in the systems and methods described herein. As illustrated, the ICE 100 may include a plurality of alternating layers 102 and 104, such as silicon (Si) and SiO₂ (quartz), respectively. In general, these layers 102, 104 consist of materials whose index of refraction is high and low, respectively. Other examples might include niobia and niobium, germanium and germania, MgF₂, SiO₂, and other high and low index materials known in the art. The layers 102, 104 may be strategically deposited on an optical substrate 106. In some embodiments, the optical substrate 106 is BK-7 optical glass. In other embodiments, the optical substrate 106 may be another type of optical substrate, such as quartz, sapphire, silicon, germanium, zinc selenide, zinc sulfide, or various plastics such as polycarbonate, polymethylmethacrylate (PMMA), polyvinylchloride (PVC), diamond, ceramics, combinations thereof, and the like.

At the opposite end (e.g., opposite the optical substrate 106 in FIG. 1), the ICE 100 may include a layer 108 that is generally exposed to the environment of the device or installation. The number of layers 102, 104 and the thickness of each layer 102, 104 are determined from the spectral attributes acquired from a spectroscopic analysis of a characteristic of the hazardous substance using a conventional spectroscopic instrument. The spectrum of interest of a given characteristic of a hazardous substance typically includes any number of different wavelengths. It should be understood that the exemplary ICE 100 in FIG. 1 does not in fact represent any particular characteristic of a given hazardous substance, but is provided for purposes of illustration only. Consequently, the number of layers 102, 104 and their relative thicknesses, as shown in FIG. 1, bear no correlation to any particular characteristic of a given hazardous substance. Nor are the layers 102, 104 and their relative thicknesses necessarily drawn to scale, and therefore should not be considered limiting of the present disclosure. Moreover, those skilled in the art will readily recognize that the materials that make up each layer 102, 104 (i.e., Si and SiO₂) may vary, depending on the application, cost of materials, and/or applicability of the material to the given hazardous substance.

In some embodiments, the material of each layer 102, 104 can be doped or two or more materials can be combined in a manner to achieve the desired optical characteristic. In addition to solids, the exemplary ICE 100 may also contain liquids and/or gases, optionally in combination with solids, in order to produce a desired optical characteristic. In the case of gases and liquids, the ICE 100 can contain a corresponding vessel (not shown), which houses the gases or liquids. Exemplary variations of the ICE 100 may also include holographic optical elements, gratings, piezoelectric, light pipe, digital light pipe (DLP), and/or acousto-optic elements, for example, that can create transmission, reflection, and/or absorptive properties of interest.

The multiple layers 102, 104 exhibit different refractive indices. By properly selecting the materials of the layers 102, 104 and their relative thickness and spacing, the ICE 100 may be configured to selectively pass/reflect/refract predetermined fractions of electromagnetic radiation at different wavelengths. Each wavelength is given a predetermined weighting or loading factor. The thickness and spacing of the layers 102, 104 may be determined using a variety of approximation methods from the spectrograph of the characteristic or analyte of interest. These methods may include inverse Fourier transform (IFT) of the optical transmission spectrum and structuring the ICE 100 as the physical representation of the IFT. The approximations convert the IFT into a structure based on known materials with constant refractive indices. Further information regarding the structures and design of exemplary integrated computational elements (also referred to as multivariate optical elements) is provided in Applied Optics, Vol. 35, pp. 5484-5492 (1996) and Vol. 129, pp. 2876-2893, which is hereby incorporated by reference.

The weightings that the layers 102, 104 of the ICE 100 apply at each wavelength are set to the regression weightings described with respect to a known equation, or data, or spectral signature. Briefly, the ICE 100 may be configured to perform the dot product of the input light beam into the ICE 100 and a desired loaded regression vector represented by each layer 102, 104 for each wavelength. As a result, the output light intensity of the ICE 100 is related to the characteristic or analyte of interest. Further details regarding how the exemplary ICE 100 is able to distinguish and process electromagnetic radiation related to the characteristic or analyte of interest are described in U.S. Pat. Nos. 6,198,531; 6,529,276; and 7,920,258, previously incorporated herein by reference.

Referring now to FIG. 2, illustrated is a block diagram that non-mechanistically illustrates how an optical computing device 200 is able to distinguish electromagnetic radiation related to a characteristic or hazardous substance of a fluid from other electromagnetic radiation. As shown in FIG. 2, after being illuminated with incident electromagnetic radiation, a fluid 202 that may contain a hazardous substance produces an output of electromagnetic radiation (e.g., sample-interacted light), some of which is electromagnetic radiation 204 corresponding to the hazardous substance and some of which is background electromagnetic radiation 206 corresponding to other components or characteristics of the fluid 202. In some embodiments, the fluid 202 may be seawater or another body of water, and the hazardous substance may be present within the seawater in any concentration or amount.

Although not specifically shown, one or more spectral elements may be employed in the device 200 in order to restrict the optical wavelengths and/or bandwidths of the system and thereby eliminate unwanted electromagnetic radiation existing in wavelength regions that have no importance. Such spectral elements can be located anywhere along the optical train, but are typically employed directly after the light source, which provides the initial electromagnetic radiation. Various configurations and applications of spectral elements in optical computing devices may be found in commonly owned U.S. Pat. Nos. 6,198,531; 6,529,276; 7,123,844; 7,834,999; 7,911,605; 7,920,258; 8,049,881 and U.S. patent application Ser. No. 12/094,460 (U.S. Pat. App. Pub. No. 2009/0219538); Ser. No. 12/094,465 (U.S. Pat. App. Pub. No. 2009/0219539); and Ser. No. 13/456,467, incorporated herein by reference, as indicated above.

The beams of electromagnetic radiation 204, 206 impinge upon the optical computing device 200, which contains an exemplary ICE 208 therein. The ICE 208 may be similar to the ICE 100 of FIG. 1, and therefore will not be described again in detail. In the illustrated embodiment, the ICE 208 may be configured to produce optically interacted light, for example, transmitted optically interacted light 210 and reflected optically interacted light 214. In operation, the ICE 208 may be configured to distinguish the electromagnetic radiation 204 from the background electromagnetic radiation 206.

The transmitted optically interacted light 210, which may be related to the hazardous substance or a characteristic of interest of the hazardous substance in the fluid 202, may be conveyed to a detector 212 for analysis and quantification. In some embodiments, the detector 212 is configured to produce an output signal in the form of a voltage that corresponds to the particular characteristic of the fluid 202. In at least one embodiment, the signal produced by the detector 212 and the concentration of the characteristic or hazardous substance of the fluid 202 may be directly proportional. In other embodiments, the relationship may be a polynomial function, an exponential function, and/or a logarithmic function. The reflected optically interacted light 214, which may be related to characteristics of other components of the fluid 202, can be directed away from detector 212. In alternative configurations, the ICE 208 may be configured such that the reflected optically interacted light 214 can be related to the hazardous substance, and the transmitted optically interacted light 210 can be related to other components of the fluid 202.

In some embodiments, a second detector 216 can be present and arranged to detect the reflected optically interacted light 214. In other embodiments, the second detector 216 may be arranged to detect the electromagnetic radiation 204, 206 derived from the fluid 202 or electromagnetic radiation directed toward or before the fluid 202. Without limitation, the second detector 216 may be used to detect radiating deviations stemming from an electromagnetic radiation source (not shown), which provides the electromagnetic radiation (i.e., light) to the device 200. For example, radiating deviations can include such things as, but not limited to, intensity fluctuations in the electromagnetic radiation, interferent fluctuations (e.g., dust or other interferents passing in front of the electromagnetic radiation source), coatings on windows included with the optical computing device 200, combinations thereof, or the like. In some embodiments, a beam splitter (not shown) can be employed to split the electromagnetic radiation 204, 206, and the transmitted or reflected electromagnetic radiation can then be directed to one or more ICE 208. That is, in such embodiments, the ICE 208 does not function as a type of beam splitter, as depicted in FIG. 2, and the transmitted or reflected electromagnetic radiation simply passes through the ICE 208, being computationally processed therein, before travelling to or otherwise being detected by the detector 212.

The characteristic(s) of the fluid 202 being analyzed using the optical computing device 200 can be further processed computationally to provide additional characterization information about the fluid 202 or the hazardous substance present therein. In some embodiments, the identification and concentration of each analyte or hazardous substance in the fluid 202 can be used to predict certain physical characteristics of the fluid 202. For example, the bulk characteristics of a fluid 202 can be estimated by using a combination of the properties conferred to the fluid 202 by each analyte or hazardous substance.

In some embodiments, the concentration of each hazardous substance or the magnitude of each characteristic of the hazardous substance determined using the optical computing device 200 can be fed into an algorithm operating under computer control. The algorithm may be configured to make predictions on how the characteristics of the fluid 202 change if the concentrations of the hazardous substances or analytes are changed relative to one another. In some embodiments, the algorithm can produce an output that is readable by an operator who can manually take appropriate action, if needed, based upon the output. In other embodiments, the algorithm can be programmed to take proactive process control by automatically initiating a remedial effort when a predetermined toxicity level of the hazardous substance is reported or otherwise detected.

The algorithm can be part of an artificial neural network configured to use the concentration of each detected hazardous substance in order to evaluate the overall characteristic(s) of the fluid 202 and thereby determine when a predetermined toxicity level has been reached or otherwise surpassed. Illustrative but non-limiting artificial neural networks are described in commonly owned U.S. patent application Ser. No. 11/986,763 (U.S. Patent App. Pub. No. 2009/0182693), which is incorporated herein by reference. It is to be recognized that an artificial neural network can be trained using samples of hazardous substances having known concentrations, compositions, and/or properties, and thereby generating a virtual library. As the virtual library available to the artificial neural network becomes larger, the neural network can become more capable of accurately predicting the characteristics of a fluid having any number of hazardous substances or analytes present therein. Furthermore, with sufficient training, the artificial neural network can more accurately predict the characteristics of the fluid, even in the presence of unknown hazardous substances.

It is recognized that the various embodiments herein directed to computer control and artificial neural networks, including various blocks, modules, elements, components, methods, and algorithms, can be implemented using computer hardware, software, combinations thereof, and the like. To illustrate this interchangeability of hardware and software, various illustrative blocks, modules, elements, components, methods and algorithms have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application. Further, various components and blocks can be arranged in a different order or partitioned differently, for example, without departing from the scope of the embodiments expressly described.

Computer hardware used to implement the various illustrative blocks, modules, elements, components, methods, and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable read only memory (EPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

In some embodiments, the data collected using the optical computing devices can be archived along with data associated with operational parameters being logged at a job site. Evaluation of job performance can then be assessed and improved for future operations or such information can be used to design subsequent operations. In addition, the data and information can be communicated (wired or wirelessly) to a remote location by a communication system (e.g., satellite communication or wide area network communication) for further analysis. The communication system can also allow remote monitoring and operation of a process to take place. Automated control with a long-range communication system can further facilitate the performance of remote job operations. In particular, an artificial neural network can be used in some embodiments to facilitate the performance of remote job operations. That is, remote job operations can be conducted automatically in some embodiments. In other embodiments, however, remote job operations can occur under direct operator control, where the operator is not at the job site but able to access the job site via wireless communication.

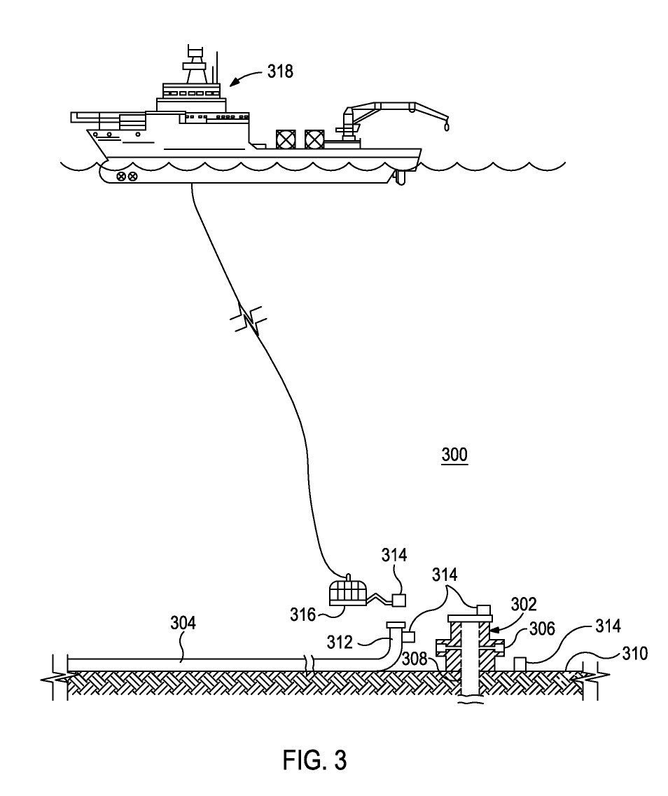

Referring now to FIG. 3, illustrated is an exemplary oceanic environment 300 that is being monitored for the presence of one or more hazardous substances, according to one or more embodiments disclosed. Specifically, FIG. 3 depicts one or more subsea equipment, such as a wellhead installation 302 and a subsea pipeline 304, that are being monitored for leakage or emission(s) of at least one hazardous substance. While only the wellhead installation 302 and the subsea pipeline 304 are shown in FIG. 3, those skilled in the art will appreciate that any subsea equipment as defined herein may be included in the exemplary oceanic environment 300 for monitoring, without departing from the scope of the disclosure. Moreover, while the wellhead installation 302 and the subsea pipeline 304 are depicted as being located in the oceanic environment 300, they may equally be submersed in any marine environment or any body of water. Accordingly, the oceanic environment 300 may include such marine environments as a lake, a stream, a river, or any containment vessel that contains water or any other liquid.

In some embodiments, the wellhead installation 302 may be installed on the seabed 310 and include one or more blow out preventers 306. As known in the art, the wellhead installation 302 may provide a point of fluid communication to a wellbore 308 that extends downward from the seabed 310. The subsea pipeline 304 may be a submarine pipeline configured to that carry or otherwise convey oil and/or gas products from a wellhead (not shown) to, for example, a riser foot 312, which may provide a connection point for conveying the oil and/or gas to a remote processing facility (not shown).

In some embodiments, the fluid (e.g., seawater) of the oceanic environment 300 surrounding the wellhead installation 302 and subsea pipeline 304 may be monitored using one or more exemplary optical computing devices 314. In at least one embodiment, an optical computing device 314 may be installed on or otherwise form part of a remote operated vehicle (ROV) 316. As illustrated, the ROV 316 may be tethered to a supply vessel 318 located at the surface 320 via a control line 322. While depicted in FIG. 3 as a ship or barge, the supply vessel 318 may be any type of surface or sub-surface facility used to provide support, service, or maintenance for the particular subsea application. For instance, the supply vessel 318 may also refer to a submersible or semi-submersible platform or rig, without departing from the scope of the disclosure. The control line 322 may facilitate communication between the ROV 316 and the supply vessel 318 such that data that is obtained by the optical computing device 314 installed on the ROV 316 may be transmitted directly to the supply vessel 318 for analysis and consideration. The control line 322 may also facilitate the operational control (e.g., underwater movement, positioning, etc.) of the ROV 316 such that an operator located on the supply vessel 318 is able to manipulate the position of the ROV 316 around various portions of the subsea equipment and the ROV is able to traverse the oceanic environment 300. In other embodiments, however, the control line 322 may be omitted and the ROV 316 may wirelessly communicate with the supply vessel 318, and the optical computing device 314 may also be configured to wirelessly transmit any recorded data to a corresponding receiver (not shown) arranged at the supply vessel 318.

While FIG. 3 depicts a supply vessel 318 as a point of receipt for various data obtained or otherwise recorded by the optical computing device 314 installed on the ROV 316, the supply vessel 318 may be replaced with or represent any other offshore facility known to those skilled in the art, without departing from the scope of the disclosure. For example, the supply vessel 318 could instead be a submersible or semi-submersible platform or rig, or a jack-up rig. In other embodiments, the supply vessel 318 could correspond to or otherwise be a mooring, one or more buoys, towed vehicles or arrays, an autonomous underwater vehicle, a manned underwater vehicle (e.g., the “Alvin” underwater vehicle) or such like), one or more deployment platforms, or the like. In yet other embodiments, the supply vessel 318 may be omitted altogether and the optical computing device(s) 314 may instead be configured to wirelessly communicate with a remote land-based location using, for example, satellite or radio frequency transmission technology.

In some embodiments, one or more optical computing devices 314 may be coupled to or otherwise strategically arranged on or about the wellhead installation 302 and/or the subsea pipeline 304 in order to monitor the surrounding seawater of the oceanic environment 300 for the presence of any hazardous substances. In yet other embodiments, one or more optical computing devices 314 may be arranged on the seabed 310 for monitoring the surrounding seawater. While only a few optical computing devices 314 are depicted in FIG. 3, it will be appreciated that any number of optical computing devices 314 may be employed, without departing from the scope of the disclosure. Each optical computing device 314 may include a subsea wireless link (not shown), or the like, and be configured to wirelessly transmit the data to the supply vessel 318 or some other remote location for analysis and consideration. Any type of wireless telecommunication technology and related devices may be used in order to transmit the data to the supply vessel 318 for example, but not limited to, acoustic energy, optical fibers, sonar (e.g., ultra short baseline, long baseline, short basic line), radio frequency, electromagnetic radiation (e.g., LED, LCD display, light bulb, etc.), global positioning systems, lasers, combinations thereof, and the like. In other embodiments, one or more of the optical computing device(s) 314 may be configured to store the obtained data in an on-board memory for subsequent downloading upon retrieval or access.

In some embodiments, the hazardous substance to be monitored in the oceanic environment 300 may be a hydrocarbon that may leak or otherwise emit from the wellhead installation 302 and/or the subsea pipeline 304, or any other subsea equipment defined herein. In other embodiments, the hazardous substance is any of the hazardous substances generally defined herein. Monitoring the seawater surrounding the wellhead installation 302 and/or the subsea pipeline 304 for such hazardous substances may help determine whether the surrounding oceanic environment 300 is considered “healthy” in accordance with environmental regulations, and/or whether any remedial efforts should be undertaken to reverse any excessively toxic readings. In some embodiments, the optical computing devices 314 may also provide an early warning alert that a leak has formed in the subsea equipment such that appropriate corrective measures or repairs may be undertaken. Otherwise, as briefly mentioned above, the optical computing devices 314 may be configured to provide periodic or predetermined alerts indicating that a predetermined healthy limit has not been surpassed or otherwise breached, thereby informing operators that the oceanic environment 300 remains in a “healthy” condition.

In other embodiments, the optical computing devices 314 may be useful in long time monitoring applications of the oceanic environment 300. For example, in some case, especially following an industrial accident or after the subsea equipment has been removed from the oceanic environment 300, the optical computing device 314 may remain in order to periodically provide updates on the toxicity level or general health of the oceanic environment 300. In some cases, the optical computing devices 314 may monitor and report the long range drift of a hydrocarbon spill or monitoring ship traffic related hazardous substances. In such applications, the optical computing devices may be mounted, for example, on the hull of a ship or on a buoy, and be configured to make sure no contamination has reached sensitive waters, such as the arctic oceanic environment.

In yet other embodiments, the optical computing devices 314 may be useful in monitoring the subsea pipeline 304 prior to production operations. For example, subsea pipelines 304 are typically tested prior to being placed online for production. Part of the testing procedure is a pressure test where a dye or similar substance is injected into the pipeline 304 and the pipeline 304 is then monitored as to whether the dye can be seen leaking at any point. Here, the optical computing devices 314 may be useful in monitoring the subsea pipeline 304 for the emission of a dye (or the like) during a testing operation. In the event a leak is detected, the pipeline 304 may be repaired prior to full commission in the oceanic environment 300.

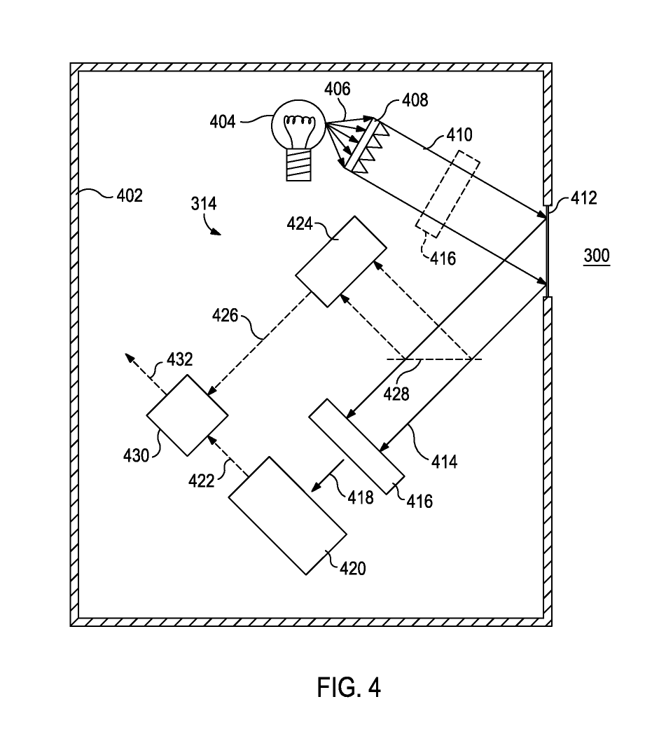

Referring now to FIG. 4, with continued reference to FIG. 3, illustrated is an exemplary schematic view of the optical computing device 314, according to one or more embodiments. Those skilled in the art will readily appreciate that the optical computing device 314, and its components described below, are not necessarily drawn to scale nor, strictly speaking, depicted as optically correct as understood by those skilled in optics. Instead, FIG. 4 is merely illustrative in nature and used generally herein in order to supplement understanding of the description of the various exemplary embodiments. Nonetheless, while FIG. 4 may not be optically accurate, the conceptual interpretations depicted therein accurately reflect the exemplary nature of the various embodiments disclosed.

As briefly described above, the optical computing device 314 may be arranged or otherwise configured to determine a particular characteristic of the surrounding oceanic environment 300, such as determining a concentration of a hazardous substance that may be present therein. Knowing the concentration of known hazardous substance(s) may help determine the overall quality or health of the oceanic environment 300 and indicate a need to remedy potentially undesirable levels of hazardous substances in the oceanic environment 300.

As illustrated, the optical computing device 314 may be housed within a casing or housing 402 configured to substantially protect the internal components of the device 314 from damage or contamination from the oceanic environment 300. In some embodiments, the housing 402 may operate to mechanically couple the device 314 to the subsea equipment (not shown), such as the wellhead installation 302 and/or the subsea pipeline 304 of FIG. 3, with, for example, mechanical fasteners, brazing or welding techniques, adhesives, magnets, combinations thereof, or the like. The housing 402 may be designed to withstand the pressures that may be experienced within the oceanic environment 300 and thereby provide a fluid tight seal against external contamination.

The device 314 may include an electromagnetic radiation source 404 configured to emit or otherwise generate electromagnetic radiation 406. The electromagnetic radiation source 404 may be any device capable of emitting or generating electromagnetic radiation, as defined herein. For example, the electromagnetic radiation source 404 may be a light bulb, a light emitting device (LED), a laser, a blackbody, a photonic crystal, an X-Ray source, combinations thereof, or the like. In some embodiments, a lens 408 may be configured to collect or otherwise receive the electromagnetic radiation 406 and direct a beam 410 of electromagnetic radiation 406 toward a location for sampling the oceanic environment 300. The lens 408 may be any type of optical device configured to transmit or otherwise convey the electromagnetic radiation 406 as desired. For example, the lens 408 may be a normal lens, a Fresnel lens, a diffractive optical element, a holographic graphical element, a mirror (e.g., a focusing mirror), a type of collimator, or any other electromagnetic radiation transmitting device known to those skilled in art. In other embodiments, the lens 408 may be omitted from the device 314 and the electromagnetic radiation 406 may instead be directed toward the oceanic environment 300 directly from the electromagnetic radiation source 404.

In one or more embodiments, the device 314 may also include a sampling window 412 arranged adjacent to or otherwise in contact with the oceanic environment 300 on one side for detection purposes. The sampling window 412 may be made from a variety of transparent, rigid or semi-rigid materials that are configured to allow transmission of the electromagnetic radiation 406 therethrough. For example, the sampling window 412 may be made of, but is not limited to, glasses, plastics, semi-conductors, crystalline materials, polycrystalline materials, hot or cold-pressed powders, combinations thereof, or the like. In order to remove ghosting or other imaging issues resulting from reflectance on the sampling window 412, the system 300 may employ one or more internal reflectance elements (IRE), such as those described in co-owned U.S. Pat. No. 7,697,141, and/or one or more imaging systems, such as those described in co-owned U.S. patent application Ser. No. 13/456,467, the contents of each hereby being incorporated by reference.

After passing through the sampling window 412, the electromagnetic radiation 406 impinges upon and optically interacts with the oceanic environment 300, including any hazardous substances present therein. As a result, optically interacted radiation 414 is generated by and reflected from the oceanic environment 300. Those skilled in the art, however, will readily recognize that alternative variations of the device 314 may allow the optically interacted radiation 414 to be generated by being transmitted, scattered, diffracted, absorbed, emitted, or re-radiated by and/or from the oceanic environment 300, or one or more hazardous substances present within the oceanic environment 300, without departing from the scope of the disclosure.

The optically interacted radiation 414 generated by the interaction with the oceanic environment 300, and at least one hazardous substance present therein, may be directed to or otherwise be received by an ICE 416 arranged within the device 314. The ICE 416 may be a spectral component substantially similar to the ICE 100 described above with reference to FIG. 1. Accordingly, in operation the ICE 416 may be configured to receive the optically interacted radiation 414 and produce modified electromagnetic radiation 418 corresponding to a particular characteristic or hazardous substance of interest of the oceanic environment 300. In particular, the modified electromagnetic radiation 418 is electromagnetic radiation that has optically interacted with the ICE 416, whereby an approximate mimicking of the regression vector corresponding to the characteristic or hazardous substance in the oceanic environment 300 is obtained.

It should be noted that, while FIG. 4 depicts the ICE 416 as receiving reflected electromagnetic radiation from the oceanic environment 300, the ICE 416 may be arranged at any point along the optical train of the device 314, without departing from the scope of the disclosure. For example, in one or more embodiments, the ICE 416 (as shown in dashed) may be arranged within the optical train prior to the sampling window 412 and equally obtain substantially the same results. In other embodiments, the sampling window 412 may serve a dual purpose as both a transmission window and the ICE 416 (i.e., a spectral component). In yet other embodiments, the ICE 416 may generate the modified electromagnetic radiation 418 through reflection, instead of transmission therethrough.

Moreover, while only one ICE 416 is shown in the device 314, embodiments are contemplated herein which include the use of two or more ICE components in the device 314, each being configured to cooperatively determine the characteristic or hazardous substance of interest in the oceanic environment 300. For example, two or more ICE components may be arranged in series or parallel within the device 314 and configured to receive the optically interacted radiation 414 and thereby enhance sensitivities and detector limits of the device 314. In other embodiments, two or more ICE components may be arranged on a movable assembly, such as a rotating disc or an oscillating linear array, which moves such that the individual ICE components are able to be exposed to or otherwise optically interact with electromagnetic radiation for a distinct brief period of time. The two or more ICE components in any of these embodiments may be configured to be either associated or disassociated with the characteristic of the oceanic environment 300 or a hazardous substance present therein. In other embodiments, the two or more ICE components may be configured to be positively or negatively correlated with the characteristic of the oceanic environment 300 or a hazardous substance present therein. These optional embodiments employing two or more ICE components are further described in co-pending U.S. patent application Ser. Nos. 13/456,264, 13/456,405, 13/456,302, and 13/456,327, the contents of which are hereby incorporated by reference in their entireties.

In some embodiments, it may be desirable to monitor more than one characteristic or hazardous substance of interest at a time using the device 314. In such embodiments, various configurations for multiple ICE components can be used, where each ICE component is configured to detect a particular and/or distinct characteristic or hazardous substance of interest. In some embodiments, the characteristic or hazardous substance can be analyzed sequentially using the multiple ICE components that are provided a single beam of electromagnetic radiation being reflected from or transmitted through the oceanic environment 300. In some embodiments, as briefly mentioned above, multiple ICE components can be arranged on a rotating disc, where the individual ICE components are only exposed to the beam of electromagnetic radiation for a short time. Advantages of this approach can include the ability to analyze multiple hazardous substances within the oceanic environment 300 using a single optical computing device and the opportunity to assay additional hazardous substances simply by adding additional ICE components to the rotating disc. In various embodiments, the rotating disc can be turned at a frequency of about 10 RPM to about 30,000 RPM such that each hazardous substance present in the oceanic environment 300 is measured rapidly. In some embodiments, these values can be averaged over an appropriate time domain (e.g., about 1 millisecond to about 1 hour) to more accurately determine the characteristics of the oceanic environment 300.

In other embodiments, multiple optical computing devices 314 can be used at a single location (or at least in close proximity) within the oceanic environment 300, where each optical computing device 314 contains a unique ICE component that is configured to detect a particular characteristic or hazardous substance of interest present in the oceanic environment 300. Each optical computing device 314 can be coupled to a corresponding detector or detector array that is configured to detect and analyze an output of electromagnetic radiation from the respective optical computing device 314. Parallel configurations of optical computing devices 314 can be particularly beneficial for applications that require low power inputs and/or no moving parts.

Those skilled in the art will appreciate that any of the foregoing configurations can further be used in combination with a series configuration in any of the present embodiments. For example, two optical computing devices having a rotating disc with a plurality of ICE components arranged thereon can be placed in series for performing an analysis at a single location (or at least on close proximity) within the oceanic environment 300. Likewise, multiple detection stations, each containing optical computing devices in parallel, can be placed in series for performing a similar analysis.

The modified electromagnetic radiation 418 generated by the ICE 416 may subsequently be conveyed to a detector 420 for quantification of the signal. The detector 420 may be any device capable of detecting electromagnetic radiation, and may be generally characterized as an optical transducer. In some embodiments, the detector 420 may be, but is not limited to, a thermal detector such as a thermopile or photoacoustic detector, a semiconductor detector, a piezoelectric detector, a charge coupled device (CCD) detector, a video or array detector, a split detector, a photon detector (such as a photomultiplier tube), photodiodes, combinations thereof, or the like, or other detectors known to those skilled in the art.

In some embodiments, the detector 420 may be configured to produce an output signal 422 in real-time or near real-time in the form of a voltage (or current) that corresponds to the particular characteristic or hazardous substance of interest in the oceanic environment 300. The voltage returned by the detector 420 is essentially the dot product of the optical interaction of the optically interacted radiation 414 with the respective ICE 416 as a function of the concentration of the characteristic or hazardous substance of interest of the oceanic environment 300. As such, the output signal 422 produced by the detector 420 and the concentration of the characteristic or hazardous substance of interest in the oceanic environment 300 may be related, for example, directly proportional. In other embodiments, however, the relationship may correspond to a polynomial function, an exponential function, a logarithmic function, and/or a combination thereof.

In some embodiments, the device 314 may include a second detector 424, which may be similar to the first detector 420 in that it may be any device capable of detecting electromagnetic radiation. Similar to the second detector 216 of FIG. 2, the second detector 424 of FIG. 4 may be used to detect radiating deviations stemming from the electromagnetic radiation source 404. Undesirable radiating deviations can occur in the intensity of the electromagnetic radiation 406 due to a wide variety of reasons and potentially causing various negative effects on the device 314. These negative effects can be particularly detrimental for measurements taken over a period of time. In some embodiments, radiating deviations can occur as a result of a build-up of film or material on the sampling window 412 which has the effect of reducing the amount and quality of light ultimately reaching the first detector 420. Without proper compensation, such radiating deviations could result in false readings and the output signal 422 would no longer be primarily or accurately related to the characteristic or hazardous substance of interest.

To compensate for these types of undesirable effects, the second detector 424 may be configured to generate a compensating signal 426 generally indicative of the radiating deviations of the electromagnetic radiation source 404, and thereby normalize the output signal 422 generated by the first detector 420. As illustrated, the second detector 424 may be configured to receive a portion of the optically interacted radiation 414 via a beamsplitter 428 in order to detect the radiating deviations. In other embodiments, however, the second detector 424 may be arranged to receive electromagnetic radiation from any portion of the optical train in the device 314 in order to detect the radiating deviations, without departing from the scope of the disclosure.

In some applications, the output signal 422 and the compensating signal 426 may be conveyed to or otherwise received by a signal processor 430 communicably coupled to both the detectors 420, 424. The signal processor 430 may be a computer including a non-transitory machine-readable medium, and may be configured to computationally combine the compensating signal 426 with the output signal 422 in order to normalize the output signal 422 in view of any radiating deviations detected by the second detector 424. In some embodiments, computationally combining the output and compensating signals 422, 426 may entail computing a ratio of the two signals 422, 426. For example, the concentration of each hazardous substance or the magnitude of each characteristic determined using the optical computing device 314 can be fed into an algorithm run by the signal processor 430. The algorithm may be configured to make predictions on how the characteristics of the oceanic environment 300 change if the concentrations of the hazardous substances are changed relative to one another.

In real-time or near real-time, the signal processor 430 may be configured to provide a resulting output signal 432 corresponding to the characteristic of interest, such as the concentration of the hazardous substance present in the oceanic environment 300. In some embodiments, as briefly discussed above, the resulting signal output signal 432 may be conveyed, either wired or wirelessly, to an operator at the surface for analysis and consideration. Upon review of the resulting output signal, the operator may be able to determine which hazardous substances are present in the oceanic environment 300, and in what concentration. When the oceanic environment 300 is deemed “unhealthy” as a result of the presence of excessive hazardous substances, the operator may initiate remedial efforts designed to remove the hazardous substances and/or stop the influx of additional hazardous substances (e.g., repair a leak in subsea equipment).

In other embodiments, the resulting output signal 432 may be recognized by the signal processor 430 as being within or without a predetermined or preprogrammed range of suitable operation. For example, the signal processor 430 may be programmed with a toxicity profile that corresponds to one or more hazardous substances. The toxicity profile may be a measurement of a concentration or percentage of one or more hazardous substances within the oceanic environment 300. In some embodiments, the toxicity profile may be measured in the parts per thousand range, the parts per million range, the parts per billion range, or any other suitable range of measurement. If the resulting output signal 432 exceeds or otherwise falls within a predetermined or preprogrammed range of operation for the toxicity profile, the signal processor 430 may be configured to alert the user (wired or wirelessly) of an excessive amount of hazardous substance(s) so appropriate corrective action may be initiated. In some embodiments, the signal processor 430 may be configured to autonomously undertake the appropriate corrective action. For example, the signal processor 430 may be configured to transmit a signal (e.g., RF, optical, acoustic, electromagnetic, etc.) to an adjacent safety system (not shown) configured to close one or more valves in order to stop a leak of a hazardous substance.

In some cases, the resulting output signal 432, in conjunction with resulting output signals 432 of one or more other optical computing devices 314, may provide the user or operator with a chemical map of the detected substances. The chemical map may, for example, be useful in determining or otherwise estimating the dispersion of the substance being monitored within the oceanic environment 300. In other applications, the chemical map may be useful in determining the heading and/or speed of the monitored substance within the oceanic environment 300. This may prove especially advantageous following a spill or accident. In such cases, the chemical map may be used to track the spilled substance(s) and even predict its movements based on known oceanic currents.

Still referring to FIG. 4, those skilled in the art will readily recognize that, in one or more embodiments, electromagnetic radiation may be derived from the oceanic environment 300 itself, and otherwise derived independent of the electromagnetic radiation source 404. For example, various substances naturally radiate electromagnetic radiation that is able to optically interact with the ICE 416. In some embodiments, for example, the oceanic environment 300 or the substance within the oceanic environment 300 may be a blackbody radiating substance configured to radiate heat that may optically interact with the ICE 416. In other embodiments, the oceanic environment 300 or the substance within the oceanic environment 300 may be radioactive or chemo-luminescent and, therefore, radiate electromagnetic radiation that is able to optically interact with the ICE 416. In yet other embodiments, the electromagnetic radiation may be induced from the oceanic environment 300 or the hazardous substance within the oceanic environment 300 by being acted upon mechanically, magnetically, electrically, combinations thereof, or the like. For instance, in at least one embodiment, a voltage may be applied to the oceanic environment 300 in order to induce the electromagnetic radiation. As a result, embodiments are contemplated herein where the electromagnetic radiation source 404 is omitted from the particular optical computing device.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A system, comprising:
one or more subsea equipment arranged in an oceanic environment; and
at least one optical computing device arranged on or in proximity to the one or more subsea equipment for monitoring the oceanic environment, the at least one optical computing device having at least one integrated computational element configured to optically interact with the oceanic environment and thereby generate optically interacted light, and at least one detector arranged to receive the optically interacted light and generate an output signal corresponding to a characteristic of the oceanic environment.

2. The system of claim 1, wherein the characteristic of the oceanic environment is a hazardous substance present within the oceanic environment.

3. The system of claim 2, wherein the characteristic is a concentration of the hazardous substance in the oceanic environment.

4. The system of claim 2, wherein the hazardous substance is a hydrocarbon leaking from the one or more subsea equipment.

5. The system of claim 2, wherein the hazardous substance is a dye leaking from the one or more subsea equipment.

6. The system of claim 1, wherein the one or more subsea equipment is a remote operated vehicle.

7. The system of claim 1, wherein the one or more subsea equipment comprises one selected from the group consisting of a wellhead, a blow out preventer, a packer, a hanger, a subsea separation system, a subsea gas compression system, a process facility, a flowline, a flowline connection point, a pipeline, a pipeline end manifold, a hose, an umbilical line, a hydraulic line, a control systems a flow hub, a casing, a production tubular, a subsea storage vessel, a transport vessel, a subterranean formation, a surface-controlled subsurface safety valve, an actuator, a valve, a valve control system, a buoy, and a hull of a ship.

8. The system of claim 1, wherein the at least one optical computing device is arranged on a seabed near the one or more subsea equipment.

9. The system of claim 1, further comprising a signal processor communicably coupled to the at least one detector for receiving the output signal, the signal processor being configured to determine the characteristic of the oceanic environment.

10. The system of claim 1, wherein the at least one optical computing device further comprises an electromagnetic radiation source configured to emit electromagnetic radiation that optically interacts with the oceanic environment.

11. The system of claim 10, wherein the at least one detector is a first detector and the system further comprises a second detector arranged to detect the electromagnetic radiation from the electromagnetic radiation source and thereby generate a compensating signal indicative of electromagnetic radiating deviations.

12. The system of claim 11, further comprising a signal processor communicably coupled to the first and second detectors, the signal processor being configured to receive and computationally combine the output and compensating signals in order to normalize the output signal and determine the characteristic of the oceanic environment.

13. A method of monitoring a fluid, comprising:
arranging at least one optical computing device within an oceanic environment that includes one or more subsea equipment, the at least one optical computing device having at least one integrated computational element and at least one detector arranged therein;
disposing the at least one optical computing device on or in proximity to the one or more subsea equipment; and
generating an output signal corresponding to a characteristic of the oceanic environment with the at least one detector.

14. The method of claim 13, wherein generating the output signal corresponding to the characteristic of the oceanic environment further comprises:
optically interacting electromagnetic radiation from the oceanic environment with the at least one integrated computational element;
generating optically interacted light from the at least one integrated computational element; and
receiving the optically interacted light with the at least one detector.

15. The method of claim 14, wherein optically interacting electromagnetic radiation from the oceanic environment further comprises optically interacting the electromagnetic radiation with a hazardous substance present within the oceanic environment.

16. The method of claim 13, wherein the characteristic of the oceanic environment is a concentration of a hazardous substance present within the oceanic environment.

17. The method of claim 13, further comprising arranging the optical computing device on the one or more subsea equipment.

18. The method of claim 13, further comprising arranging the optical computing device on a seabed near the one or more subsea equipment.

19. The method of claim 13, further comprising:
receiving the output signal with a signal processor communicably coupled to the at least one detector; and
determining the characteristic of the oceanic environment with the signal processor.

20. The method of claim 13, wherein the at least one detector is a first detector, the method further comprising:
emitting electromagnetic radiation from an electromagnetic radiation source arranged in the at least one optical computing device;
receiving and detecting with a second detector at least a portion of the electromagnetic radiation;
generating with the second detector a compensating signal indicative of radiating deviations of the electromagnetic radiation source; and
computationally combining the output signal and the compensating signal with a signal processor communicably coupled to the first and second detectors, whereby the characteristic of the oceanic environment is determined.

21. A method of monitoring a quality of a fluid, comprising:
optically interacting electromagnetic radiation from an oceanic environment with at least one integrated computational element, thereby generating optically interacted light, wherein the oceanic environment has one or more subsea equipment arranged therein;
receiving with at least one detector the optically interacted light;
measuring a characteristic of at least one hazardous substance present in the oceanic environment with the at least one detector;
generating an output signal corresponding to the characteristic of the at least one hazardous substance in the oceanic environment; and
undertaking at least one corrective step when the characteristic of the at least one hazardous substance in the oceanic environment surpasses a predetermined range of suitable operation.

22. The method of claim 21, wherein the characteristic of at least one hazardous substance is the concentration of the at least one hazardous substance in the oceanic environment.

23. The method of claim 21, wherein undertaking the at least one corrective step comprises initiating one or more remedial efforts to remove the at least one hazardous substance from the oceanic environment.
